(19) United States
(12) Patent Application Publication
(10) Pub. No.: US 2009/0144629 A1
(43) Pub. Date: Jun. 4, 2009

(54) Controlling Application for a Multifunction Peripheral Accessed and Operated from a Mobile Device

(76) Inventors: Andrew Rodney Ferlitsch, Camas, WA (US); Tanna Marie Richardson, Happy Valley, OR (US)

Correspondence Address: KIRTON & MCCONKIE, 1800 EAGLE GATE TOWER / 60 EAST SOUTH TEMPLE, P.O. BOX 45120, SALT LAKE CITY, UT, 84145-0120, US

(21) Appl. No.: 11/947,593

(22) Filed: Nov. 29, 2007

(51) Int. Cl. G06F 15/177

(52) U.S. Cl. 715/736

(57) ABSTRACT

Methods and systems are provided that use a controlling application for a multifunction peripheral (MFP) that is external to the MFP and need not be preinstalled on the network or pre-registered with the MFP. The controlling application may be on a mobile device that is communicatively coupled with the MFP or a system or network of the MFP via a wireless connection. The controlling application may be downloaded from the mobile device or a data source to a service hosting service communicatively coupled to the network. The controlling application is then operative from the user interface of the mobile device. This permits a user to control the MFP from the mobile device and receive by-products of actions taken by the MFP at the mobile device.

### BACKGROUND OF THE INVENTION

1. Field of the Invention

The present invention relates to controlling a network device using a mobile device, and more particularly to systems and methods for providing a controlling application for a network device such as a multifunction peripheral that may be controlled at a mobile device and that does not need to be pre-installed on the network or pre-registered with the network device.

2. Background and Related Art

Firmware is and has been developed for controlling and enhancing the operation of a multifunction peripheral (MFP) or multifunction printer using web services. In one mode, the scan operation of an MFP is enhanced, whereby a remote application controls both the user interface (UI) on the MFP and the scan operations. As one example, the remote application is used to perform a scan to server operation whereby the scanned data is processed by the server and the post-processed data is then passed to one or more client destinations. In another mode, a walkup universal serial bus (USB) print operation of an MFP is enhanced, whereby a remote application controls both the UI on the MFP and the print operations. As an example, the remote application is used to perform a print from removable storage operation; the file data is converted to printer-ready data by a server, and the printer-ready data is sent back to the MFP for printing.

But, the above-described implementations are limited to have a controlling application preloaded on an external server and registered with the MFP. Additionally, such implementations are limited to operating the device as a walkup device. Also, the target of the operation (e.g., scan) is limited to a fixed computing device.

One method of a remote application controlling an MFP can be demonstrated through a method as depicted in FIG. 1. In this method, the front panel of the MFP and operation of the MFP are under the control of a remote application. In one example, the remote application can be a scan to server process, as described above. By using this method, the user has the added advantage of eliminating human errors, since the MFP is under the control of a remote application that can enforce the correct process flow. Additionally, since the method is implemented using web services, the operation can optionally include secure transport and authentication, which is built into the web services.

But the method is limited in several ways. First it is limited to a scan operation. Second, the controlling application must pre-exist on the external server. Third, the controlling application must be pre-registered on the MFP. Fourth, the method is limited to being operated from the MFP's front panel.

Another example is illustrated in FIG. 2. In this method, an external server provides file format conversion web services to an MFP. This web service can be used to enhance the support of file formats to print. For example, when receiving a USB walkup print, the MFP will check if a conversion web service is registered. If so, the MFP queries the web service for additional file formats that can be supported (as native printing), by utilizing the conversion services of the server. The additionally file formats (e.g., MS-Word) are then combined with the MFP's native formats (e.g., PCL, Postscript, PDF) to expand the file browser when browsing files on removable storage or other accessible storage.

This method is also limited in several ways. It is limited to print operations only. It is not a controlling application, but only provides additional services. The application must be preloaded on web server and pre-registered with the MFP. Additionally, the method is limited to being operated from the MFP's front panel.

A third example is shown in FIG. 3. In this method, a user can have a personalized controlling application on removable storage, such as on a USB flash memory device. When the removable storage is inserted into the MFP, the MFP detects the presence of the controlling application. The controlling application is then pulled from the removable storage and dynamically loaded onto the external server and launched as the controlling application for the MFP. The user then operates the MFP via the user's personalized controlling application, which is running on the external server and controlling the MFP and the MFP's UI.

But this example is still limited, in that: the method is limited to being operated from the MFP's front panel and no mechanism is provided whereby the target device may be a mobile device. Additionally, the controlling application must be on the removable storage. Thus, each of the above-described methods is limited.

### BRIEF SUMMARY OF THE INVENTION

Effective methods and systems are provided that use a controlling application for a network device that is external to the network device. The network device may be illustrated as a multifunction peripheral or multifunction printer (MFP). The controlling application is not required to be either pre-installed on a network server or pre-registered/pre-discovered by the MFP. Additionally, the controlling application may be on a mobile device that is communicatively coupled with the MFP or a system or network of the MFP via a wireless connection. The controlling application is operative from the user interface (UI) of the mobile device. This permits a user to control the MFP from the mobile device and receive by-products of actions taken by the MFP at the mobile device.

In embodiments of the invention, an MFP can be under the control of a controlling application that is external to the MFP. The controlling application may control operations on the MFP, such as: a front panel UI, imaging operations, such as fax, scan, and print, filing, pre-processing operations, such as preprocessing print data, and post-processing operations, such as post-processing scan data on a server. The MFP may be communicatively coupled with a mobile device. The mobile device may have an internal datastore or be communicatively coupled with a datastore service.

In some embodiments of the invention, a controlling application for controlling the MFP is stored on the mobile device, such as in a datastore service for a cell phone. When the mobile device is within communicative proximity of a network containing the MFP that the user desires to control, the mobile device searches for a service hosting service or service hosting server within the network. If one is detected, the mobile device uploads the controlling application to the service hosting service. The mobile device may supply other additional information to the service hosting service, such as the target MFP(s), initial settings, means to communicate with the mobile device, etc.

Once the controlling application is loaded on the service hosting service, the mobile device may request the service hosting service to launch the controlling application. The controlling application may then present a UI interface for the controlling application on the UI of the mobile device. The user of the mobile device may then interact with the controlling application (and thus the target MFP(s)) via the UI interface on the mobile device. The user's UI responses are then sent back to the controlling application for interpretation.

As part of the interpretation, the controlling application may generate actions for the target MFP(s) to perform. If the controlling application generates such actions, the generated actions are then sent to the target MFP(s). The target MFP(s) perform the action(s) and may respond with results or notifications back to the controlling application. The controlling application may also forward notifications back to the mobile device for display on the UI.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates one method of a remote application controlling a multifunction peripheral (MFP);

FIG. 2 shows a method for providing remote file conversion to an MFP;

FIG. 3 shows a method for providing a controlling application for an MFP on a removable storage device that is connected to the MFP at the time of use of the controlling application;

FIG. 4 illustrates a representative computer-based environment for use with embodiments of the present invention;

FIG. 5 illustrates a representative network environment for use with embodiments of the invention;

FIG. 6 provides an alternative depiction of a computer/network environment for embodiments of the invention;

FIG. 7 illustrates storage of a controlling application on a data store accessible to a mobile device;

FIG. 8 illustrates methods of delivery of the controlling application from the data store to a service hosting service at the direction of the mobile device;

FIG. 9 shows the controlling application executing on the service hosting service providing a user interface to the mobile device to allow the user at the mobile device to operate the controlling application;

FIG. 10 illustrates the user controlling functions of the MFP by operating the controlling application at the user interface on the mobile device;

FIGS. 11-13 provide alternative depictions of potential operating locations of the controlling application and mechanisms for delivery of the controlling application from the data store to the desired operating location;

FIGS. 14-16 provide alternative depictions of potential operating locations of the controlling application and mechanisms for delivery of the controlling application from an external data source to the desired operating location; and

FIG. 17 depicts a flow chart of methods in accordance with embodiments of the present invention.

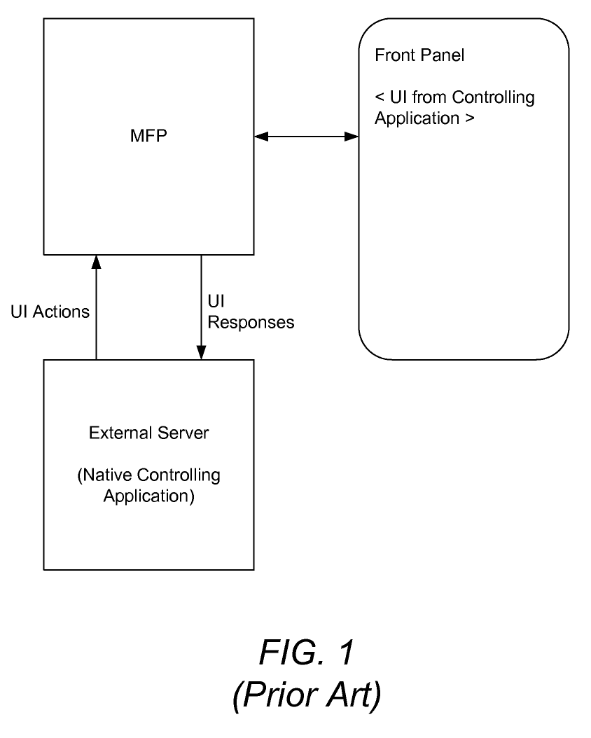

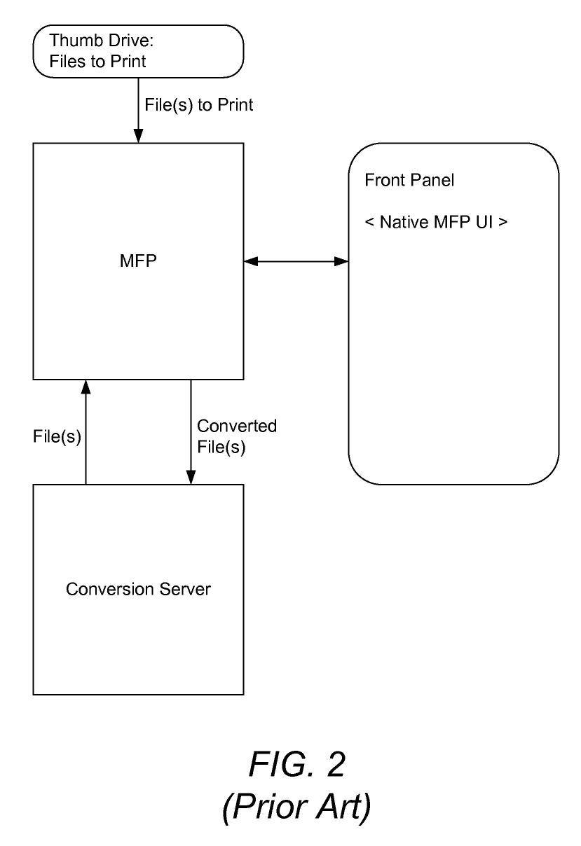

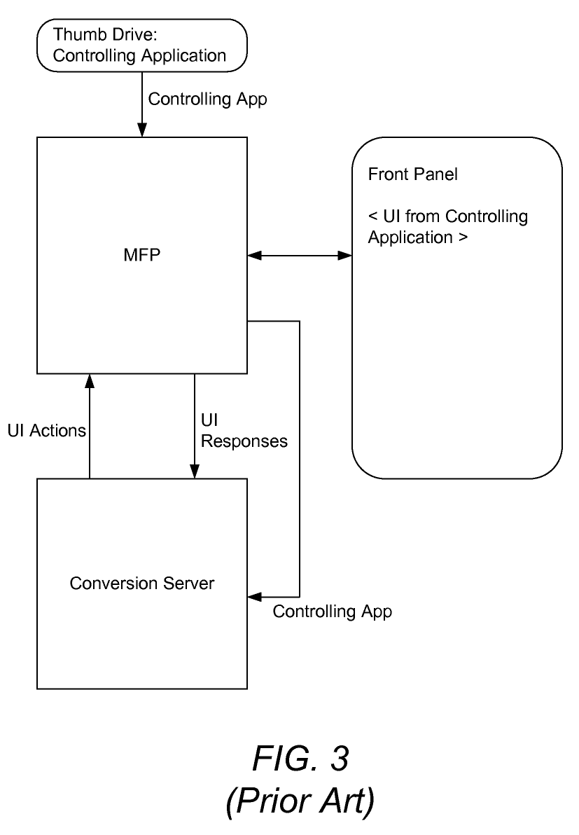

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The following description of the embodiments of the invention discloses effective systems and methods for using a controlling application for a network device such as a multifunction peripheral or multifunction printer (MFP) that is external to the network device/MFP. The controlled network device may be any network device, such as a printer, scanner, facsimile machine, filing machine, media duplication device, film printer, or MFP, but in the description, reference will be made primarily to MFPs by way of example. The controlling application is not required to be either pre-installed on a server or pre-registered/pre-discovered by the MFP. The controlling application may initially be located on a mobile device which is communicatively coupled with the MFP or a system or network of the MFP via a wireless network connection. The controlling application is operative from the user interface (UI) of the mobile device.

One exemplary operating environment includes an MFP, which can be under the control of a controlling application that is external to the MFP. The controlling application may control operations on the MFP, such as: a front panel UI, imaging operations, such as fax, scan, filing, duplication, and print, pre-processing operations, such as preprocessing print data, and post-processing operations, such as post-processing scan data on a server. The MFP may be communicatively coupled with a mobile device. The mobile device may have an internal datastore or be communicatively coupled with a datastore service.

In some embodiments of the invention, a controlling application (e.g., a Sharp Open Systems Architecture (Sharp OSA™) application) for controlling the MFP is stored on a mobile device, such as in a datastore service for a cell phone. When the mobile device is within communicative proximity of a network containing the MFP that the user desires to control (via the controlling application), the mobile device searches for a service hosting service or service hosting server within the network. If one is detected, the mobile device uploads the controlling application to the service hosting service. The mobile device may supply other additional information to the service hosting service, such as the target MFP(s), initial settings, means to communicate with the mobile device, etc.

Once the controlling application is uploaded, the mobile device may request the service hosting service to launch the controlling application. After the service hosting service launches the controlling application, the UI interface for the controlling application may be presented on the UI of the mobile device. The user of the mobile device may then interact with the controlling application via the UI interface on the mobile device. The user's UI responses are then sent back to the controlling application for interpretation.

As part of the interpretation, the controlling application may generate actions for the target MFP(s) to perform. If the controlling application generates such actions, the generated actions are then sent to the target MFP(s). The target MFP(s) perform the action(s) and may respond with results or notifications back to the controlling application. The controlling application may also send notifications back to the mobile device for display on the UI.

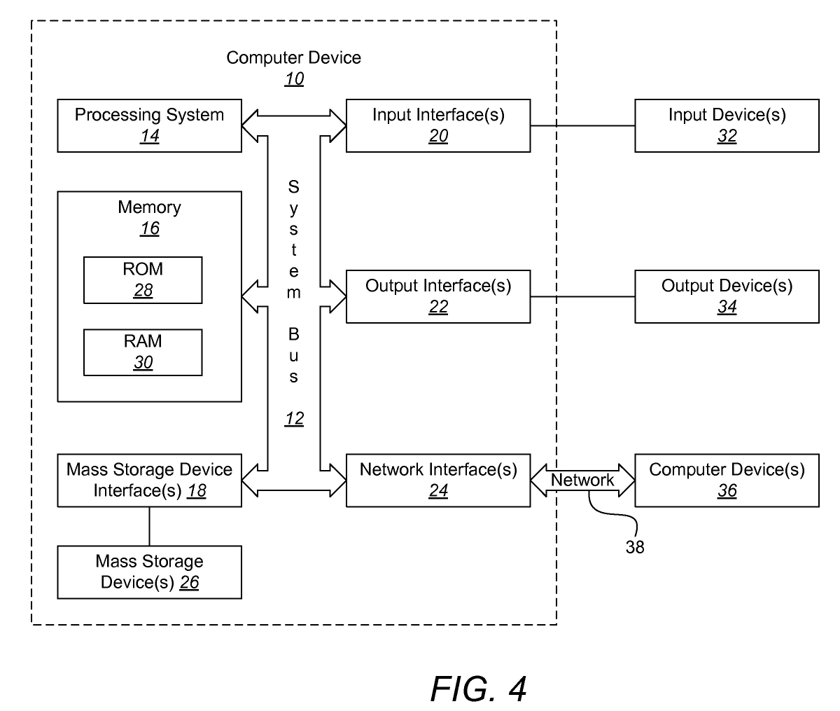

As it is anticipated that at least some embodiments of the invention comprise various types of general-purpose and specific-purpose computer devices, FIG. 4 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 4, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, a mobile computer device, a smart phone, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, a flash memory (whether removable or otherwise) or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, optical disk drives, and flash memory drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (USB), an integrated circuit, a firewire (Institute of Electrical and Electronics Engineers (IEEE) 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multifunction peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (LAN), a virtual local area network (VLAN), or a modem, wireless link, or other adapter for connection to a wide area network (WAN), such as the Internet. The network interface 24 may be incorporated with or peripheral to computer device 10. In a networked system, accessible program modules or portions thereof may be stored in a remote memory storage device. Furthermore, in a networked system, computer device 10 may participate in a distributed computing environment, where functions or tasks are performed by a plurality of networked computer devices.

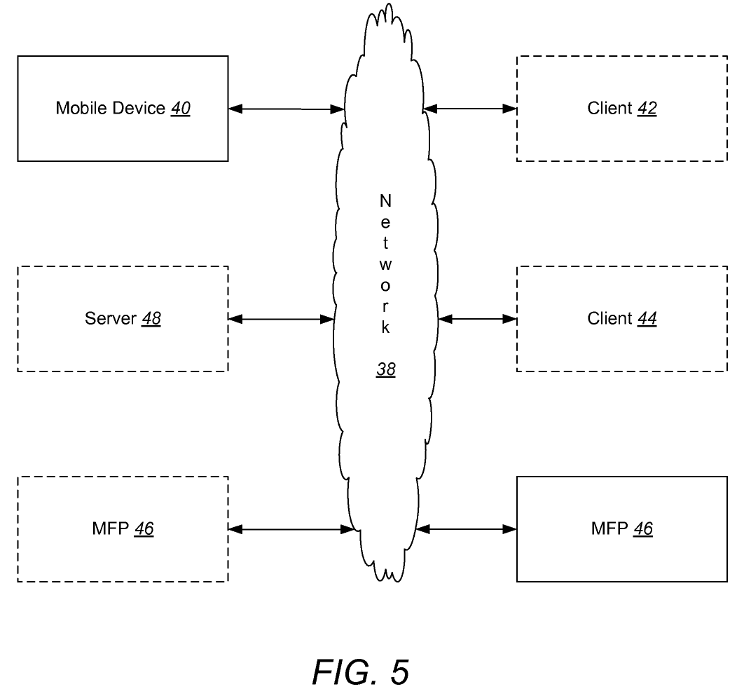

Thus, while those skilled in the art will appreciate that embodiments of the present invention may be practiced in a variety of different environments with many types of system configurations, FIG. 5 provides a representative networked system configuration that may be used in association with embodiments of the present invention. The representative system of FIG. 5 includes a computer device, illustrated as mobile device 40, which may be connected to one or more other computer devices (illustrated as client 42 and client 44, but which may also be additional mobile computing devices) and one or more peripheral devices (illustrated as MFP 46) across network 38. While FIG. 5 illustrates an embodiment that includes a mobile device 40, two optional additional client computer devices: client 42 and client 44, one peripheral device, one MFP 46 and optionally an additional MFP 46, and optionally a server 48, which may be a print server, connected to network 38, alternative embodiments include more or fewer clients, additional mobile devices 40, more than one or two peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace electronic consumer devices, wireless networked environments, and/or wide area networked environments, such as the Internet.

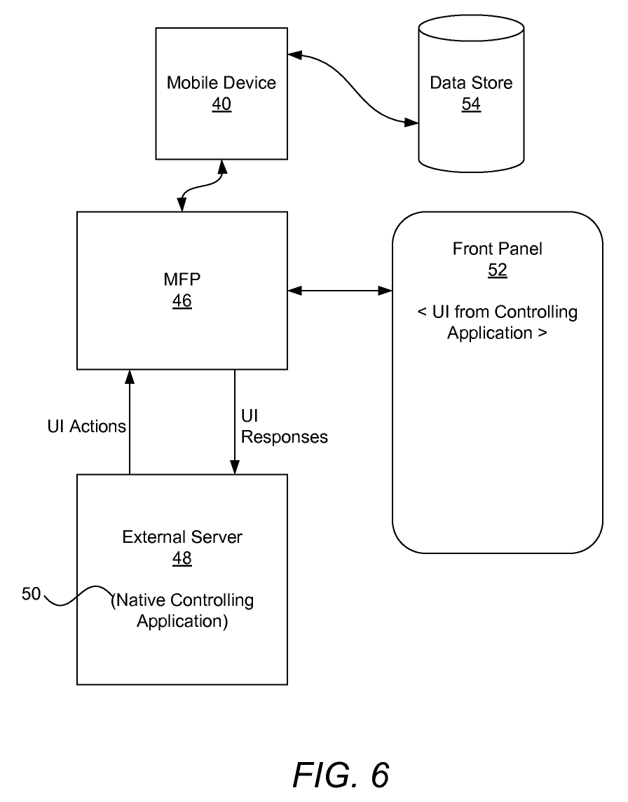

FIG. 6 provides an alternate depiction of an exemplary operating environment for embodiments of the present invention. The exemplary operating environment includes one or more MFPs 46, which may be under the control of a controlling application 50, which may be external to the MFP 46. Generally, the controlling application 50 resides and is executed on either: (1) an external computing device, such as the server 48, or (2) a guest operating system within the MFP 46. In embodiments where the controlling application 50 resides and is executed on a guest operating system within the MFP 46, the controlling application 50 may be external to the MFP 46 in that it is provided to the MFP 46 from an external source.

Generally, the controlling application can perform one or more or all of the following controlling services: (1) generating and providing the UI for a front panel 52 of the MFP 46, (2) interpreting the UI responses received at the front panel 52, (3) controlling fax, scan, filing, duplication, and print operations, (4) controlling preprocessing operations, such as converting file data into printer ready data, and (5) controlling post-processing operations, such as optical character recognition (OCR), and bates stamping of scanned image data.

In embodiments where the controlling application 50 resides and is executed on an external computing device (e.g. server 48) communication and transport of data to/from the MFP 46 and the external computing device that is hosting the controlling application 50 may be by any protocol or combination of protocols, such as: (1) web services/simpleobject access protocol (WS/SOAP), (2) SOAP/extensible markup language (SOAP/XML), (3) direct Internet message encapsulation (DIME), (4) file transfer protocol (FTP), (5) network file system (NFS), (6) simple mail transfer protocol (SMTP), (7) hypertext transfer protocol/hypertext markup language (HTTP/HTML), (8) a proprietary protocol over transmission control protocol/Internet protocol (TCP/IP), (9) Short Messaging Service (SMS), (10) MultiMedia Messaging Service (MMS), and/or (11) AppleTalk™.

Additionally, the exemplary operating environment may include one or more mobile devices 40 that is at least intermittently communicatively coupled with at least one node in the network 38 that contains the MFP 46 and the external computing device, if any. The mobile device 40 may also be at least intermittently communicatively coupled with a data store 54, which may be: (1) an internally hosted data store (e.g., a hard disk or flash memory), (2) an externally hosted data store (e.g., a data store service), or (3) a removable data store. Examples of mobile devices 40 include: (1) cell phones and smart phones, (2) Blackberry® PDAs, (3) other PDAs, (4) laptop and notebook computers, and (5) any other mobile device capable of achieving communicative coupling as set forth above.

The communicative coupling between the mobile device 40 and the at least one node and between the mobile device 40 and the data store 54 may include at least an intermittent wireless connection. For example, the mobile device 40 may be communicatively coupled by any means, such as: (1) wireless fidelity (WiFi) (Institute of Electrical & Electronics Engineers (IEEE) 802.11a, b, g, n, etc.), (2) Worldwide Interoperability for Microwave Access, Inc. (WiMax) (IEEE 802.16), (3) Bluetooth®, (4) Infrared Data Association (IrDA), and/or (5) cellular or other network connectivity. In some embodiments, the communicative coupling between the mobile device 40 and the data store 54 may include a wired connection, such as when the data store 54 is internally hosted on the mobile device 40.

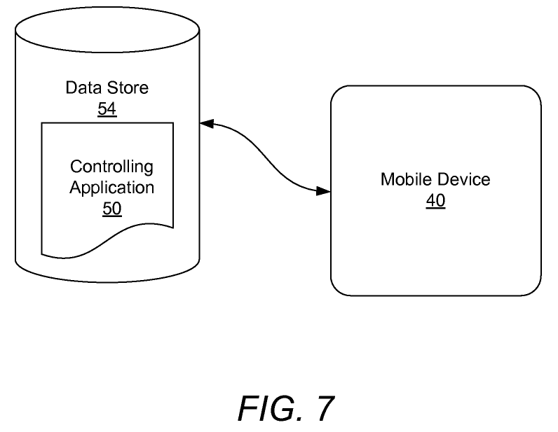

The controlling application 50 may be stored on the data store 54 accessible to the mobile device 40. In one illustrative embodiment, as illustrated in FIG. 7, one or more controlling applications 50 are stored on at least one data store 54 communicatively coupled with at least one mobile device 40 (see FIG. 6). The controlling application 50 may be in any format, such as: (1) Javascript®, (2) binary code, and (3) other interpretive languages. The controlling application(s) 50 on the data store 54 may be identified by any means, such as by: (1) file name, (2) file name sequence (e.g., regular expression match), (3) file suffix, and (4) metadata stored within or with the file. In this type of embodiment, the file(s) on the data store 54 contains the controlling application 50. In an alternate embodiment, the file(s) on the data store 54 do not contain the complete controlling application 50, but instead contain a reference (e.g., a uniform resource locator (URL)) to a separate location of the controlling application 50 (e.g., a FTP or HTTP site).

In some embodiments, the controlling application(s) 50 may be secured as only accessible via authentication and may additionally be encrypted, such as using a public key encryption (PKE encryption). Examples of authentication include (1) user identification (ID) and password, (2) personal identification (PIN) number, (3) a unique ID associated with the mobile device 40, and (4) a digital signature and certificate.

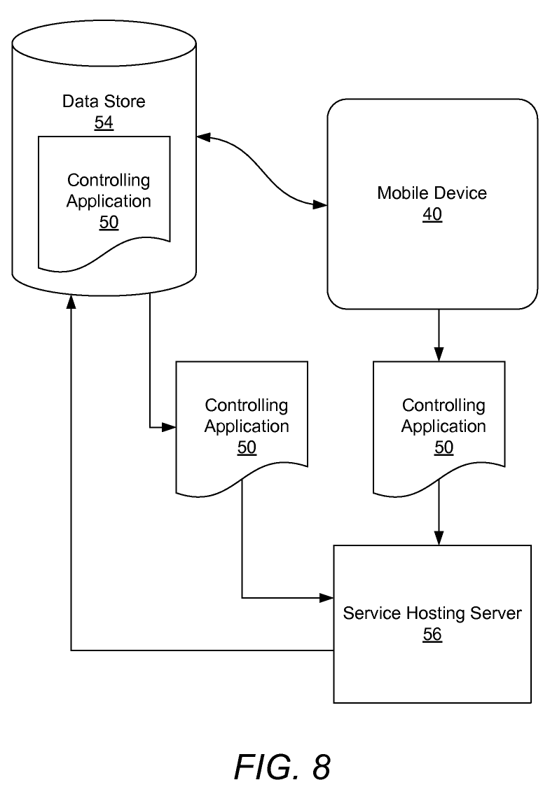

The mobile device 40 may direct the loading of the controlling application 50 into a location where the controlling application 50 can control the functions of the MFP 46. As set forth above, the location where the controlling application 50 can control the functions of the MFP 46 may include an external computer device (e.g. server 48 or the mobile device 40) and a guest operating system within the MFP 46. In some embodiments, as illustrated in FIG. 8, the mobile device 40 may detect the presence of a service hosting service or service hosting server (“service hosting service 56”). In such embodiments, the service hosting service 56 is an example of an external computing device. The mobile device 40 may detect the presence of the service hosting service 56 by any means, such as: (1) automatic (or manually initiated) discovery (e.g., web services-discovery (WS-Discovery)), (2) predetermined, or (3) manually entered (e.g., by web address of the service hosting service 56). After detecting the presence of the service hosting service 56, the mobile device 40 may connect to the service hosting service 56.

Once the mobile device 40 is connected to the service hosting service 56, the user of the mobile device 40 may select and download one or more controlling applications 50 to the service hosting service 56. The selection of the controlling application(s) 50 may be by (1) displaying a dialog on the mobile device's UI interface for selecting a controlling application 50, or (2) automatically selecting a controlling application 50, based on some criteria. In embodiments where automatic selection occurs, the automatic selecting and selection criteria may be one or more of: (a) selecting a controlling application 50 by default, when only one is present, (b) selecting a controlling application 50 relating to a selected imaging operation (e.g., scan, print, fax, file, etc), (c) selecting a controlling application 50 relating to the file format of the input data, (d) selecting a controlling application 50 relating to an imaging operation parameter (e.g., barcode, output format, compression, etc), and/or (e) selecting a controlling application 50 according to a user's role (e.g., admin assistant, realtor-agent; etc). In the case where the mobile device 40 automatically selects a controlling application 50, the mobile device 40 may determine if a controlling application 50 relates to the desired criteria by any means, such as by a name file sequence or by metadata associated with the controlling application 50.

If the user does not choose a controlling application 50, the mobile device 40 may return to normal mode, may default to a predefined controlling application 50 which is registered with the MFP 46, mobile device 40 or service hosting service 56, or may refuse access to the user. If a controlling application 50 is selected, the mobile device 40 will attempt to load the selected controlling application 50 into the service hosting service 56, which service hosting service 56 can control one or more MFPs 46. The service hosting service 56 may be provided as one of several options such as a service hosted on an external computing device (e.g. server 48), a guest operating environment within the MFP 46, or a service within the mobile device's storage.

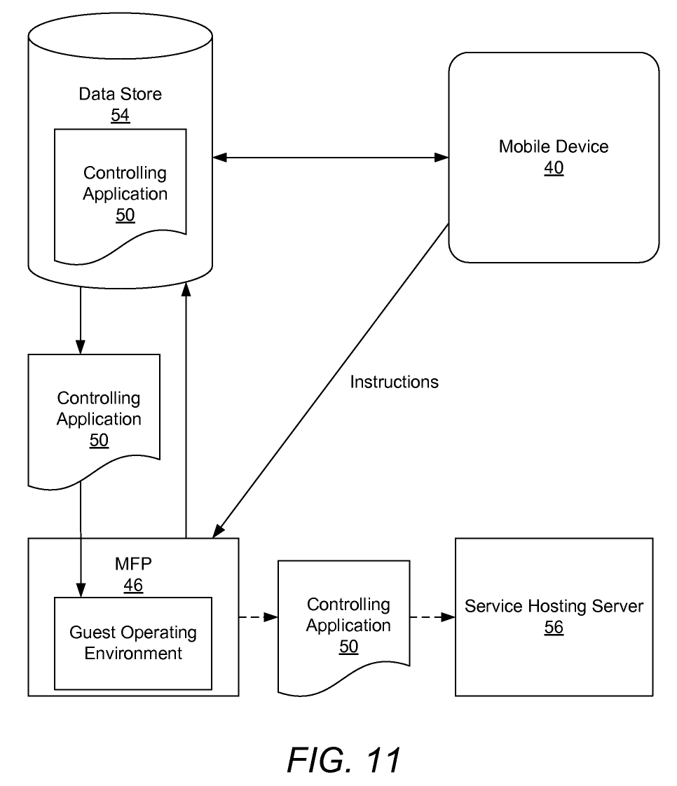

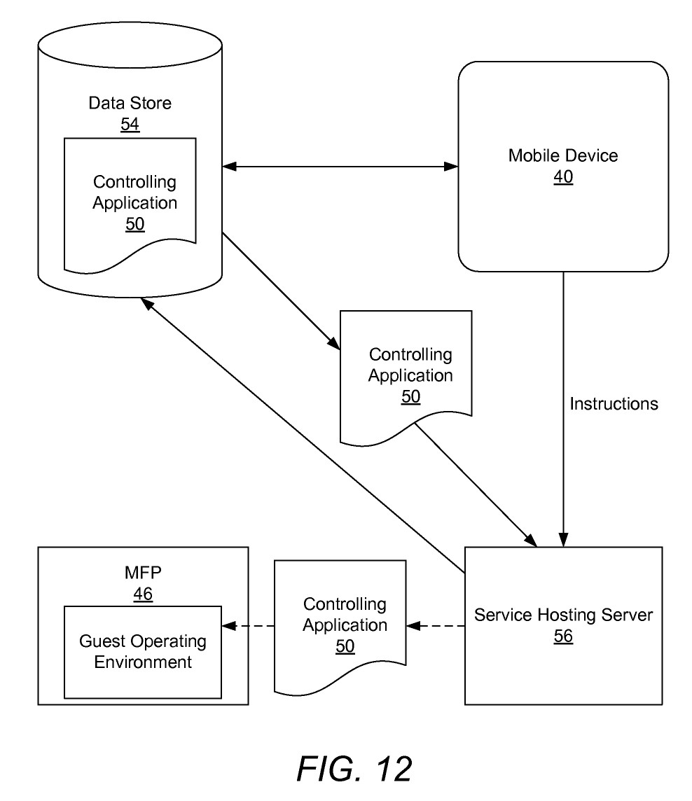

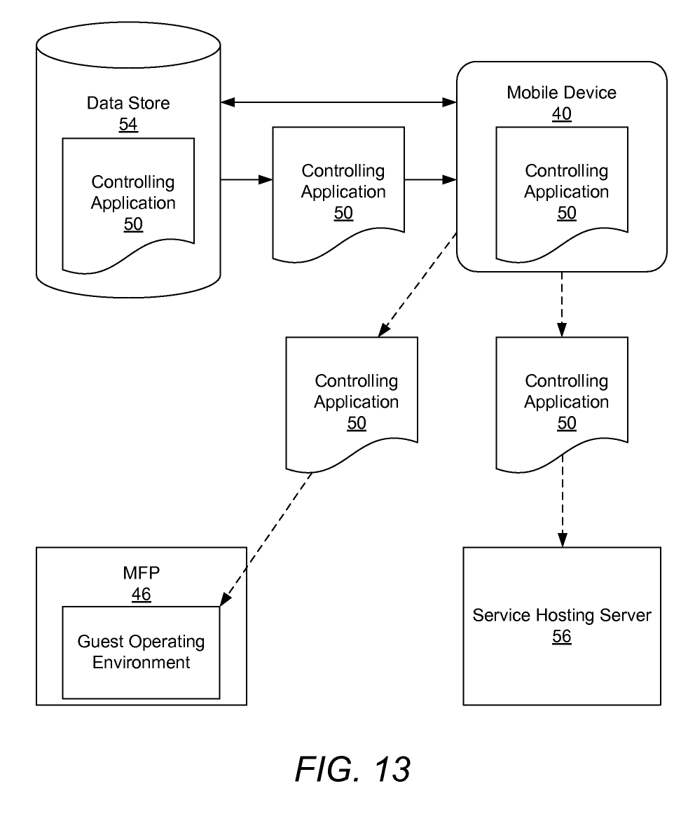

In one embodiment, the controlling application 50 is stored wholly on the data store 54. In this embodiment, the mobile device 40 may (1) instruct the MFP 46 to extract the controlling application 50 (i.e., read file data) from the data store 54 (as illustrated in FIG. 11), (2) instruct the service hosting service 56 to extract the controlling application 50 from the data store 54 (as illustrated in FIG. 12), or (3) extract the controlling application 50 from the data store 54 and directly download the controlling application 50 to the service hosting service 56, guest operating environment within the MFP 46, or service within the mobile device 40 (as illustrated in FIG. 13).

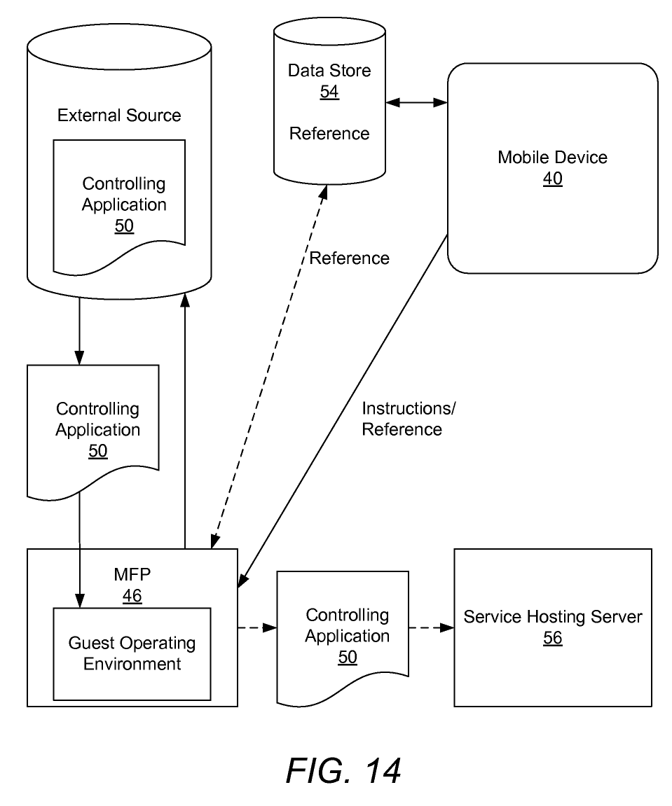

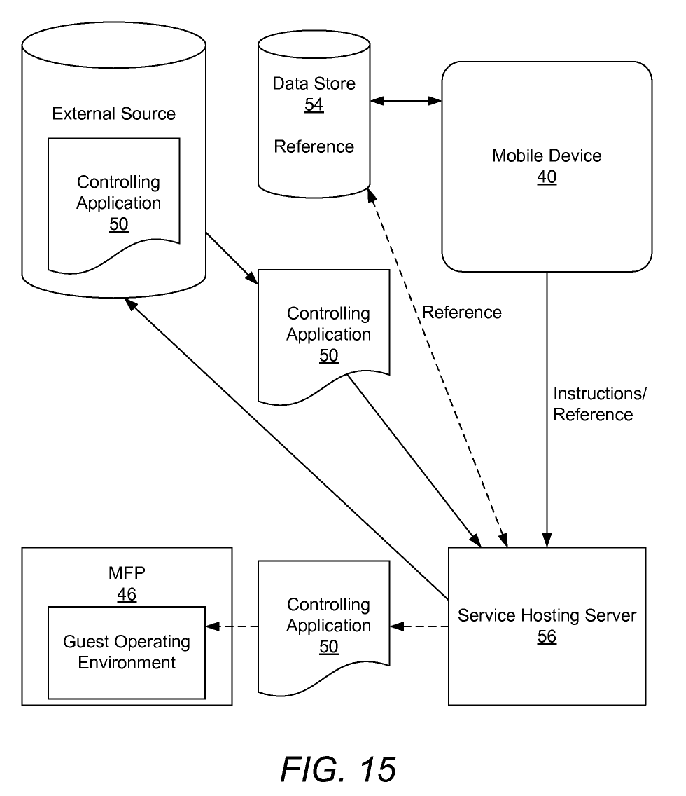

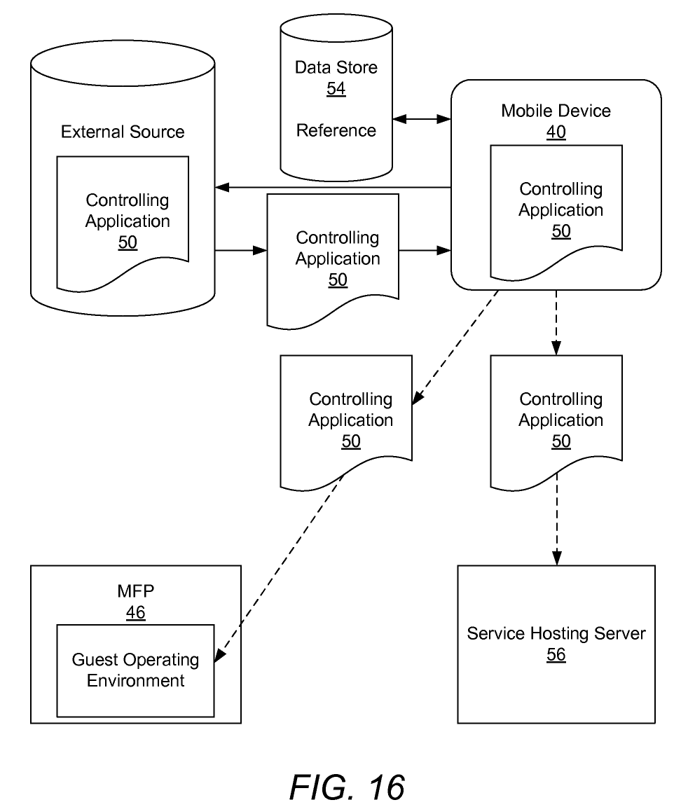

In a second embodiment, the controlling application 50 is stored externally to the data store 54, and is referenced only by a link (e.g., URL) on the data store 54. In this embodiment, the mobile device 40 may (1) instruct the MFP 46 to extract the controlling application 50 from the external source, according to the location reference (as illustrated in FIG. 14), (2) instruct the external service hosting service 56 to extract the controlling application 50 from the external source, according to the location reference, if the service hosting service 56 is communicatively coupled with the external source (as illustrated in FIG. 15), or (3) extract the controlling application 50 from the external source, according to the location reference, and directly download the controlling application 50 from the mobile device 40 to the service hosting service 56, guest operating environment within the MFP 46, or service within the mobile device 40 (as illustrated in FIG. 16).

Examples of a reference link or location reference include: a Uniform Resource Locator (URL), a Uniform-Resource-Indicator (URI), a softlink to a network file path, metadata containing a path link, and an executable, that when invoked will retrieve the controlling application 50 (e.g., batch script).

If the controlling application 50 is extracted by the MFP 46, then the MFP 46 may then load the controlling application 50 on the service hosting service 56 (see FIGS. 11 and 14). The MFP 46 may do this by any means, such as by (1) loading the controlling application 50 into a predefined location on the service hosting service 56, such as by FTP, by NFS, by AppleTalk™, by WS/SOAP, or by a proprietary method, or (2) instructing the service hosting service 56 or hosted computing environment to retrieve the controlling application 50 and to self-load the controlling application 50.) Alternatively, the MFP 46 may load the controlling application 50 on the guest operating environment of the MFP 46.

Communication of the loading of the controlling application 50 between the MFP 46 and the service hosting service 56 (or the guest operating environment or the service within the mobile device 40) may be by any means, such as (1) a continuously running process on the service hosting service 56 may monitor a predefined location for newly loaded controlling applications 50, (2) a network protocol process on the service hosting service 56 may initiate a load process based on a port or instruction within the network message packet (e.g., WS/SOAP), or (3) a remote procedure call (RPC) made from the MFP 46 to the service hosting service 56 may initiate a process on the service hosting service 56 to initiate a load process.

Once the controlling application 50 has been loaded on the service hosting service 56, the service hosting service 56 registers the controlling application 50 with one or more MFPs 46. The service hosting service 46 may register the controlling application 50 with the MFP(s) 46 by any means, such as (1) by a predetermined set configured with the service hosting service 56, (2) specified by the user as part of the upload request, or (3) dynamically discovered by the service hosting service 56. Similar actions may be taken by the service on the mobile device 40 or the guest operating environment on the MFP 46.

Once the controlling application 50 is registered with the MFP 46, the controlling application 50 may be executed and may initiate control of the MFP 46. The controlling application 50 may initiate control of the MFP 46 by manual initiation by a user at the MFP 46, by manual initiation by a user at the mobile device 40 or by automatic initiation by the service hosting service 56, the guest operating environment, or the service on the mobile device 40. Additionally, once the MFP 46 ceases to be under the control of the controlling application 50, the controlling application 50 may either continue to reside on the service hosting service 56 (or other location) and to be registered with the MFP 46 or the controlling application 50 may be unloaded from the service hosting service 56 (or other location) and be unregistered with the MFP 46. Thus, the loading and registering of the controlling application 50 may be semi-permanent or may be temporary.

The controlling application 50 may cease to control the MFP 46 by any means. Mechanisms for terminating control of the MFP 46 by the controlling application 50 include the controlling application 50 being manually terminated by the user, being automatically terminated by the service hosting service 56, the guest operating environment, or the service on the mobile device 40 at the end of an imaging operation or upon logout of the user, or being automatically terminated by the MFP 46 once the mobile device 40 is no longer communicatively coupled with the network 38.

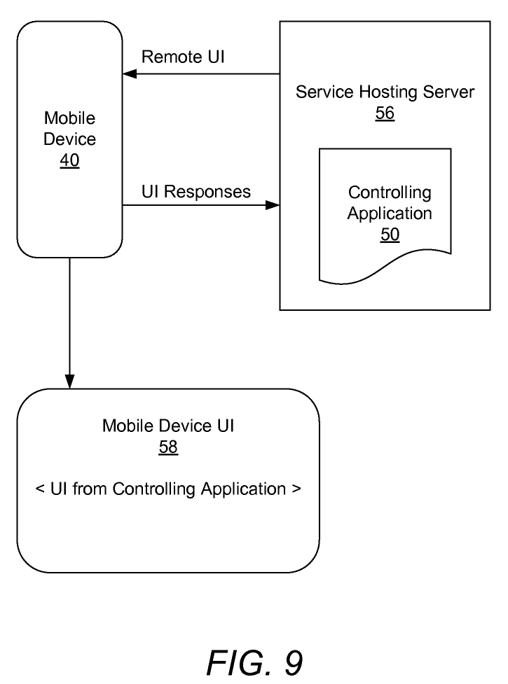

As illustrated in FIG. 9, once the controlling application 50 is initiated, the controlling application 50 displays a UI, such as a graphical user interface (GUI) on the mobile device's UI interface 58. For example, this may be done as an HTTP post to a web browser on the mobile device 40. The user then may operate the MFP 46 via the controlling application's UI on the mobile device UI interface 58. The user's UI responses are then sent back to the controlling application 50 for interpretation. Although FIG. 9 illustrates the controlling application 50 executing on the service hosting server 56, one of skill in the art will appreciate that passing of data between the mobile device's UI interface 58 and the controlling application 50 occurs similarly when the controlling application is executing on the service of the mobile device 40 or on the guest operating system of the MFP 46.

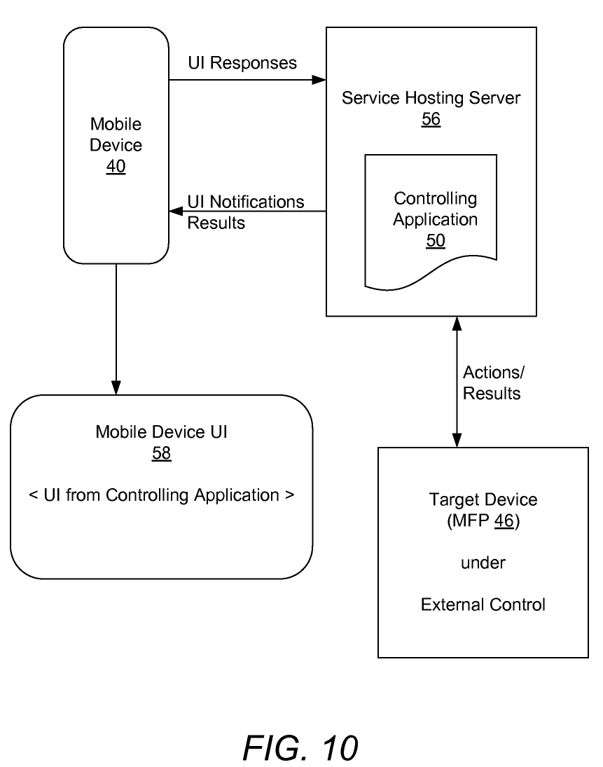

As part of the interpretation, the controlling application 50 may generate actions for the target MFP(s) 46 to perform, as illustrated in FIG. 10. When the controlling application 50 interprets the UI responses received from the mobile device 40, the controlling application 50 may perform one or more of the following: (1) send a new or updated UI back to the mobile device 40 for display on the UI Interface 58, (2) perform some local action on the service hosting service 56, (3) initiate some action on a remote computing resource or service (e.g., a web service), or (4) send actions (e.g., OSA™) to the one or more MFPs 46. Additionally, the controlling application 50 may receive notifications and by-products from the computing device(s)/MPF(s) 46 performing the requested actions. Examples of notifications include job progress and job completion. Examples of by-products include scanned image data, OCR data, forms, and other digital media.

Depending on the user interaction and the controlling application 50, the byproducts and notifications may be further forwarded back to the mobile device 40. In some cases, the byproducts and notifications may be modified to be compatible for transmission and processing by the mobile device 40.

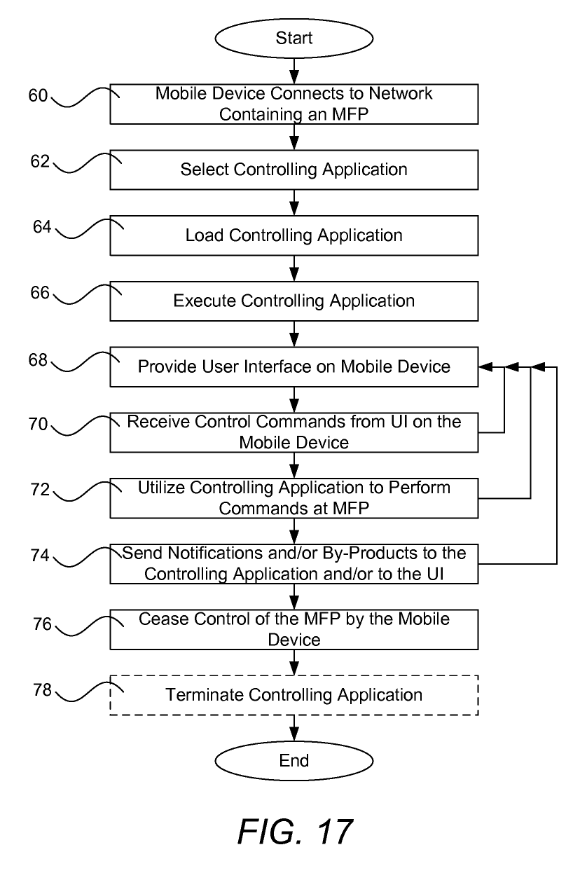

FIG. 17 illustrates processes that may occur with the embodiments of the present invention that have been set forth above. In embodiments of the invention, execution may begin at step 60, where the mobile device 40 connects to a node of a network containing a device to be controlled by the mobile device 40, such as MFP 46 on network 38. Execution then proceeds to step 62, where the user selects a controlling application 50 to use to control the MFP 46 on the network. As set forth above, the selection may be automatic based on several different criteria, or it may be selected by a manual selection by the user of the mobile device. As set forth above, the controlling application 50 selected at step 62 may be stored on the data store 54 accessible to the mobile device 40 or it may be stored on an external source with a reference on the data store 54 to locate the controlling application 50. Access to the controlling application 50 may be secured, so the user may be required to provide authentication after selecting the controlling application 50 as part of step 62.

After the controlling application 50 is selected, the controlling application 50 is loaded at step 64, and the executed at step 66. As has been discussed previously, the controlling application 50 need not have been previously installed on a server or registered with the MFP 46. The controlling application 50 may be loaded and executed on the service hosting service 56, on a service on the mobile device 40, or on a guest operating system on the MFP 46 itself. When the controlling application 50 is executed, it may assume control of the MFP 46, and may provide a UI on the mobile device 40 at step 68. Simultaneously, though not specifically illustrated in FIG. 17, the controlling application 50 may also provide a UI on the front panel 52 of the MFP 46, such as to indicate the status of the MFP 46 or for other purposes.

At step 70, the controlling application 50 may receive user input through the UI on the mobile device 40. The user input may include control commands to cause the controlling application 50 to operate the MFP 46. In some instances, the receipt of the user input and/or control commands may result in an updated UI being displayed to the user on the mobile device 40, and therefore execution may return to step 68. If the user input directs the controlling application 50 to operate the MFP, execution proceeds to step 72, where the controlling application 50 interprets the input received at the UI of the mobile device 40. In interpreting the UI input, the controlling application 50 may send a new or updated UI back to the mobile device 40 (i.e. execution returns to step 68), may perform some local action at the controlling application 50, may initiate some action on a remote computing resource or service, and/or may send actions to the MFP 46, as set forth above.

When actions are sent to and executed by the MFP 46, the MFP 46 may send notifications and/or by-products to the controlling application 50 (which may then pass the notifications and/or by-products to the mobile device 40 or the UI on the mobile device 40) and/or directly to the mobile device 40 at step 74. In some instances, the notifications and/or by-products may be converted or formatted for transmission to the mobile device 40. Execution may proceed through any of steps 68-74 repeatedly for additional actions input at the UI and or executed by the MFP 46.

At some point, such as by explicit direction of the user, automatically, or upon loss of communication between the mobile device 40 and the network 38, the controlling application 50 may cease controlling the MFP 46 at step 76. In some instances, the controlling application 50 may also be terminated/unloaded at step 78 and unregistered with the MFP 46. In other instances, the controlling application 50 may remain loaded and registered with the MFP 46.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for controlling a network device from a mobile device using a controlling application that does not have to be pre-installed on a network server or pre-registered with the network device comprising:
providing a controlling application that is not pre-installed on a server of a network containing the network device and that is not pre-registered with the network device, wherein the controlling application is communicatively accessible to at least one of:
a mobile device; and
the network containing the network device;
communicatively coupling the mobile device to the network;
loading the controlling application, at the direction of the mobile device;
initiating control of the network device by the loaded controlling application;
providing a user interface (UI) from the controlling application at the mobile device; and
operating one or more functions of the network device through the UI at the mobile device and the controlling application.

2. The method of claim 1, wherein the network device is a multifunction peripheral device (MFP).

3. The method of claim 2, wherein the controlling application is initially provided on a data store accessible by the mobile device.

4. The method of claim 3, wherein the data store is selected from the group of:
an internally-hosted data store;
an externally-hosted data store; and
a removable storage device removably and communicatively coupled to the mobile device.

5. The method of claim 2, wherein the controlling application is initially provided on an external source that is referenced by a reference link on a data store accessible to the mobile device.

6. The method of claim 2, wherein the controlling application is loaded, resides, and is executed on one of:
a computing device connected to the network that is external to the MFP and the mobile device;
a service hosting server;
a service hosting service;
a guest operating system within the MFP; and
a hosting service on the mobile device.

7. The method of claim 2, further comprising registering the controlling application with the MFP upon loading of the controlling application.

8. The method of claim 2, wherein loading the controlling application comprises downloading the controlling application from a data store of the mobile device.

9. A system for controlling a multifunction peripheral device (MFP) from a mobile device comprising:
an MFP communicatively coupled to a network;
a mobile device, wherein the mobile device is configured to wirelessly connect to the network when the mobile device is within communicative range of the network;
a data store communicatively coupled to the mobile device storing one of:
a controlling application for controlling the MFP using the mobile device; and
a reference link referencing a location of the controlling application on an external source;
the controlling application, wherein the controlling application is configured to control one or more functions of the MFP when executed, and wherein the controlling application is capable of controlling the one or more functions of the MFP without requiring that the controlling application be pre-installed on a network server of the network and without requiring that the controlling application be pre-registered with the MFP; and
a hosting service configured to host the controlling application while the controlling application controls the one or more functions of the MFP.

10. The system of claim 9, further comprising the external source storing the controlling application, wherein the external source is at least intermittently communicatively coupled to one of:
the mobile device;
the network; and
the hosting service.

11. The system of claim 9, wherein the data store is selected from the group of:
an internally-hosted data store;
an externally-hosted data store; and
a removable storage device removably and communicatively coupled to the mobile device.

12. The system of claim 9, wherein the hosting service is selected from the group of:
a service on a computing device connected to the network that is external to the MFP and the mobile device;
a service hosting server;
a service hosting service;
a guest operating system within the MFP; and
a hosting service on the mobile device.

13. The system of claim 9, wherein the controlling application is configured to:
communicate with the mobile device and the MFP;
provide a user interface for operating the MFP at the mobile device;
receive and interpret input at the user interface at the mobile device for operating the MFP; and
provide notifications and by-products of operations at the MFP to the mobile device.

14. A computer-readable medium storing a computer program product for implementing a method for controlling a multifunction peripheral device (MFP) from a mobile device using a controlling application that does not have to be pre-installed on a network server or pre-registered with the MFP, comprising computer program code means for:
communicatively and wirelessly coupling a mobile device to a network;
accessing a controlling application that is not pre-installed on a server of a network containing the MFP and that is not pre-registered with the MFP using the mobile device, wherein the controlling application is communicatively accessible to at least one of:
the mobile device;
a device on the network containing the MFP; and
the network containing the MFP;
detecting a service hosting service with the mobile device;
downloading the controlling application to the service hosting service, at the direction of the mobile device;
initiating control of the MFP by the controlling application executing on the service hosting service;
providing a user interface (UI) from the controlling application at the mobile device; and
operating one or more functions of the network device through inputs received at the UI at the mobile device and interpreted by the controlling application.

15. The computer-readable medium of claim 14, further comprising computer program code means for registering the controlling application with the MFP after downloading of the controlling application.

16. The computer-readable medium of claim 14, wherein accessing the controlling application includes accessing a data store of the mobile device, the data store being selected from the group of:
an internally-hosted data store;
an externally-hosted data store; and
a removable storage device removably and communicatively coupled to the mobile device.

17. The computer-readable medium of claim 14, wherein accessing the controlling application includes accessing a reference link on a data store of the mobile device and further accessing the controlling application on an external source referenced by the reference link, the data store being selected from the group of:
an internally-hosted data store;
an externally-hosted data store; and
a removable storage device removably and communicatively coupled to the mobile device.

18. The computer-readable medium of claim 17, wherein the external source is communicatively coupled to at least one of:
the mobile device;
a device on the network; and
the network.

19. The computer-readable medium of claim 14, wherein the computer program product includes computer program code means for loading and executing the controlling application on one of:
a computing device connected to the network, the computing device being external to the MFP and the mobile device;
a service hosting server;
a service hosting service;
a guest operating system within the MFP; and
a hosting service on the mobile device.

20. The computer-readable medium of claim 14, wherein the computer program product includes computer program code means for:
causing the controlling application to receive notifications and by-products from the MFP; and
transmitting at least one notification or by-product from the controlling application to the mobile device.
